(19) United States
(12) Patent Application Publication
(10) Pub. No.: US 2016/0219907 A1
(43) Pub. Date: Aug. 4, 2016

(54) METHOD AND SYSTEM FOR PROPAGATING SPONSORED IMAGES AND DATA ON FOOD PRODUCTS AND ASSOCIATED PACKAGING

(71) Applicant: TEN Media, LLC dba TEN Ag Tech Co., San Juan Capistrano, CA (US)

(72) Inventors: Jonathan R. Phillips, San Juan Capistrano, CA (US); Richard C. Blackburn, Santa Ana, CA (US); Scott D. Smith, Laguna Niguel, CA (US)

(73) Assignee: TEN Media, LLC dba TEN Ag Tech Co., San Juan Capistrano, CA (US)

(21) Appl. No.: 15/006,098

(22) Filed: Jan. 25, 2016

Related U.S. Application Data
(60) Provisional application No. 62/107,468, filed on Jan. 25, 2015.
(60) Provisional application No. 62/107,470, filed on Jan. 25, 2015.
(60) Provisional application No. 62/107,491, filed on Jan. 25, 2015.

(51) Int. Cl. A23L 1/32; G06Q 30/02

(52) U.S. Cl. CPC A23L 1/0252; A23L 1/32; A23V 2002/00

(57) ABSTRACT

The present disclosure includes a method and system for applying markings on a food product in such a manner to form a permanent marking thereon. The markings include text and graphics, and are suitably an advertisement, sponsored images, other promotional information, or any combination thereof. The markings may further include freshness information, traceability data, or other types of relevant information, or any combination thereof. The markings are applied by any suitable marking device known in the art, such as laser-based or ink-based technologies. The method preferably forms the markings on the food product while the product moves through a predetermined region of a food processing system.

### CROSS-REFERENCE TO RELATED APPLICATIONS

This application claims the benefit of U.S. Provisional Application No. 62/107,491 filed on Jan. 25, 2015, U.S. Provisional Application No. 62/107,468 filed on Jan. 25, 2015, and U.S. Provisional Application No. 62/107,470 filed on Jan. 25, 2015, the contents of which are incorporated herein by reference in their entirety.

### BACKGROUND

The disclosure relates generally to the field of food product processing, and more particularly methods and systems for propagating advertisements, sponsored images, other promotional information, and other relevant data on food products and associated packaging. While reference is made herein to eggs in particular, it should be understood that this disclosure is directed to all food products in which images and/or data may be applied thereon.

In the egg packing industry, eggs typically undergo a great deal of processing before they are ready to be sold to the consuming public. In many circumstances, for example, eggs pass through several processing stations where they are washed, candled, weighed, graded, and packed into packages (e.g., cartons, crates, or other commercially distributed containers). Examples of such processing stations and mechanisms for conveying eggs from station to station are described, for instance, in the following U.S. patents assigned to Diamond Automations, Inc. (U.S. Pat. Nos. 4,189,898; 4,195,736; 4,505,373; 4,519,494; 4,519,505: 4,569,444; 4,750,316; 5,321,491; and 6,056,341) and TEN Media LLC (U.S. Pat. No. 8,455,030), which are incorporated herein by reference in their entirety. As a reference, it is not uncommon for a facility in which these stations operate to output about one million eggs in a single day. Accordingly, to be commercially acceptable, the throughput of the stations needs to be quite high, with some stations typically processing on the order of 20,000 eggs per hour.

The egg packing industry uses devices known as “packers” to pack the eggs into the packages. Typically, a packer includes a conveyor (e.g., a belt conveyor, roller conveyor, chain conveyor, etc.) that moves empty packages through an egg loading section (where the eggs are loaded into the egg loading section from above) and then moves the filled packages to a package closing section that is responsible for closing the lids of the packages. The eggs may be supplied to the egg packer via a grader system.

An egg packing process that uses “packers,” typically uses bulk belts to bring eggs from a bulk supply location. The eggs are cleaned or disinfected, in some instances using UV light while clamped to transport chains, and in some instances through immersion in sanitizing wash water. The eggs are then inspected either electronically or manually, they are weighed to establish size, inspected for cracks using ultrasonic inspection and loaded into a chain driven carriage mechanism

(“Transfer Loader”). The egg is then normally transported to one of a plurality of packing machines by the aforementioned carriage mechanism. The particular packing machine to which any individual egg may be transported is determined by a computer. This process or elements thereof up to, but not including the packing machine, constitute grading (“Grading” and the “Grader”). The carriage mechanism typically consists of one or a plurality of chains, running the length of the Grader past all the packing machines in the horizontal plane (“Grader Chains”). The packing machines are usually configured with an egg flow perpendicular to the Grader Chain in the horizontal plane.

The egg industry widely uses Continuous Inkjet Printer technology (“CIJ Printers”) to print Size, Grade and Date information together with other information or images and logos (“Data”) on to the surface of an egg shell of a fresh egg travelling through an egg grading machine. The CIJ Printers are traditionally placed in a location on the production line that is responsible for grading the eggs and the site for such installation is chosen to minimize the number of CIJ Printers required for a given installation. CIJ Printers have typically been installed on the Grader Chains as near to the Transfer Loader as practical, and typically (although not always), prior to all the packing machines to which almost all eggs are later diverted.

Advertising on eggs and other food products provides a unique medium for advertisers to reach consumers. Therefore, the Data that is applied to the eggs may also include advertisements, sponsored images, and other promotional information (“Promotional Information”). Such Promotional Information needs to be applied to the eggs in manner that is likely to catch the attention of the consumer, thus the placement and the quality of the marking applied thereon are factors to consider. Moreover, the cost of the marking operation may be at least partially offset by the economic value of the Promotional Information.

As such, there is a need for a system and method to improve the reliability and quality of applying markings to eggs as well as other food products, especially advertisements, sponsored images, and other promotional information.

### BRIEF SUMMARY

The following presents a simplified overview of the example embodiments in order to provide a basic understanding of some aspects of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented later.

In accordance with embodiments herein, the present disclosure includes a method and system for applying markings on a food product in such a manner to form a permanent marking thereon. The markings include text and graphics, and are suitably an advertisement, sponsored images, other promotional information, or any combination thereof. The markings may further include freshness information, a traceability data, or other types of relevant information, or any combination thereof. The markings are applied by any suitable marking device known in the art, such as laser-based or ink-based technologies. Desirably, the marking is applied so as to leave much of the area of the food product unaffected so as to form contrast between the unaffected areas and the marking. The method preferably forms the markings on the food product while the product moves through a predetermined region of a food processing system. The performance or characteristics of the marking device may be adjusted in response to selected characteristics of the food product in order to optimize the marking applied thereon.

In a preferred embodiment, the present disclosure includes a method and system for applying markings on a food product by applying a radiant energy to the food product in such a manner to form a permanent marking thereon. A laser is preferably employed as the radiant energy source. Desirably, the radiant energy is applied so as to leave much of the area of the food product unaffected so as to form contrast between the unaffected areas and the marking. The method preferably forms the markings on the food product while the product moves through a predetermined region of a food processing system. The performance or characteristics of the laser may be adjusted in response to selected characteristics of the food product in order to optimize the marking applied thereon.

In a preferred embodiment, the present disclosure includes a method and system for applying markings on an egg by applying a radiant energy source to the shell of the egg so as to cause discoloration of the egg shell to form a permanent marking. In a preferred embodiment, the markings are made by laser etching without applying a foreign material to the egg shell.

In accordance with embodiments herein, the present disclosure includes an apparatus for applying markings on food products that is operable in association with a food packing system that packages the food products. The apparatus comprises a marking device located in proximity to the food packing system so that the marking device can form markings thereon.

A preferred embodiment includes an apparatus for applying markings on eggs that is operable in association with an egg-handling machine that performs washing, candling, grading, and packing of eggs. The apparatus comprises a marking device located in proximity to the egg-handling machine, so that the marking device can form the markings. In a preferred embodiment, the egg has a marking applied thereon, wherein the marking is formed at least in part by discolored material on the egg shell. The egg may include the marking being formed entirely by discolored material of the egg shell. The egg may also be raw or pasteurized. The markings may be formed by a generally stationary marking device as the egg is transported past the marking device.

In some embodiments, the present disclosure provides a method and system for applying markings on food products, comprising conveying the food product to a marking station having at least one laser marking device configured to apply laser energy of sufficient intensity to etch indicia on the food product, and activating the laser device to apply laser energy to the food product and etch the indicia thereon. The indicia includes text and graphics, and is suitably an advertisement, sponsored images, other promotional information, or any combination thereof. The indicia may further include a freshness date, a traceability code, other types of relevant information, or any combination thereof. In a preferred embodiment, the food product is an egg, and the laser etches the indicia on the outer surface of the shell of the egg. The applied laser energy may ablate and/or discolor the surface of the egg shell to an approximate depth that is within the range of about 5 to about 25 micrometers. The applied laser energy may ablate and/or discolor the surface of the egg shell to an approximate depth that is within the range of about 1.5 to about 8 percent of the thickness of the egg shell.

Still other advantages, aspects and features of the subject disclosure will become readily apparent to those skilled in the art from the following description wherein there is shown and described a preferred embodiment of the present disclosure, simply by way of illustration of one of the best modes best suited to carry out the subject disclosure. As it will be realized, the present disclosure is capable of other different embodiments and its several details are capable of modifications in various obvious aspects all without departing from the scope herein. Accordingly, the drawings and descriptions will be regarded as illustrative in nature and not as restrictive.

### BRIEF DESCRIPTION OF THE DRAWINGS

The accompanying drawings incorporated herein and forming a part of the specification illustrate the example embodiments.

FIG. 1 is a diagram depicting an egg bearing markings using method and apparatus embodiments of the present disclosure.

FIG. 2 is a diagram of another view of an egg bearing markings using method and apparatus embodiments of the present disclosure.

FIG. 3 is a diagram of another view of an egg bearing markings using method and apparatus embodiments of the present disclosure.

FIG. 4 is a diagram of a top view of an egg bearing markings using method and apparatus embodiments of the present disclosure.

FIG. 5 is a block diagram depicting portions of an egg-handling machine and particularly illustrating inline and offline operations.

FIG. 6 is a diagrammatic view depicting an apparatus for performing an embodiment of the method of the present disclosure.

FIG. 7 is a diagrammatic view depicting an apparatus for performing an embodiment of the method of the present disclosure.

FIG. 8 is a diagrammatic view depicting a laser printing assembly for performing an embodiment of the method of the present disclosure.

FIG. 9 illustrates an example of a computer system 900 upon which an example embodiment may be implemented.

FIG. 10 is an example flow diagram of marking on eggs with the apparatus as shown in FIGS. 6 and 7 in accordance with an example implementation.

FIG. 11 is an example flow diagram of marking on eggs with the apparatus as shown in FIGS. 6 and 7 in accordance with an example implementation.

### DETAILED DESCRIPTION OF THE PREFERRED EMBODIMENTS

This description provides examples not intended to limit the scope of the appended claims. The figures generally indicate the features of the examples, where it is understood and appreciated that like reference numerals are used to refer to like elements. Reference in the specification to “one embodiment” or “an embodiment” or “an example embodiment” means that a particular feature, structure, or characteristic described is included in at least one embodiment described herein and does not imply that the feature, structure, or characteristic is present in all embodiments described herein.

In general, the embodiments herein provide methods and systems for propagating advertisements, sponsored images, other promotional information, and other relevant data or communications on food products and associated packaging. Embodiments of the present disclosure are directed to an apparatus as well as a method for marking food products as they pass through a marking station, with the marking being carried out by marking devices that are designed and configured to render text and graphic representations as the food products pass through the marking station. While reference is made herein to eggs in particular, it should be understood that this disclosure is directed to all food products in which a mark may be applied thereon. In the example embodiment, there is provided a method and system for applying markings on an egg by a marking device so as to cause discoloration of the egg shell to form a permanent marking. However, it is to be appreciated that the embodiments of the claims herein are not limited in any way to the example embodiment, but rather are to be interpreted to cover applying markings to other suitable food products. That is, the embodiments herein can be applied to any suitable food product.

It is further understood that the preferred embodiment for applying a marking on eggs is by applying a radiant energy source to the shell of the egg so as to cause discoloration of the egg shell to form a permanent marking thereon. However, it is to be appreciated that the embodiments contained herein are not limited to the preferred embodiments, but rather are to be interpreted to cover applying markings by any suitable marking device.

It should be understood that the terms “marking” or “etching” as used herein are intended to mean that a laser is employed as a radiant energy source. The laser beam is applied to leave most of the egg shell unaffected so as to provide contrast between the unaffected areas and the marking. The laser beam ablates and/or discolors the outer surface material from the egg shell. A significant benefit of the use of laser marking is that brown eggs have etched indicia that is a contrasting white color, while white eggs have etched indicia that is a contrasting dark brown color. The structural integrity of the egg shell is not affected because the etching by the beam only affects the outer approximately 5 to approximately 25 micrometers of the egg shell, which is approximately 1.5% to approximately 8% of the thickness of the egg shell.

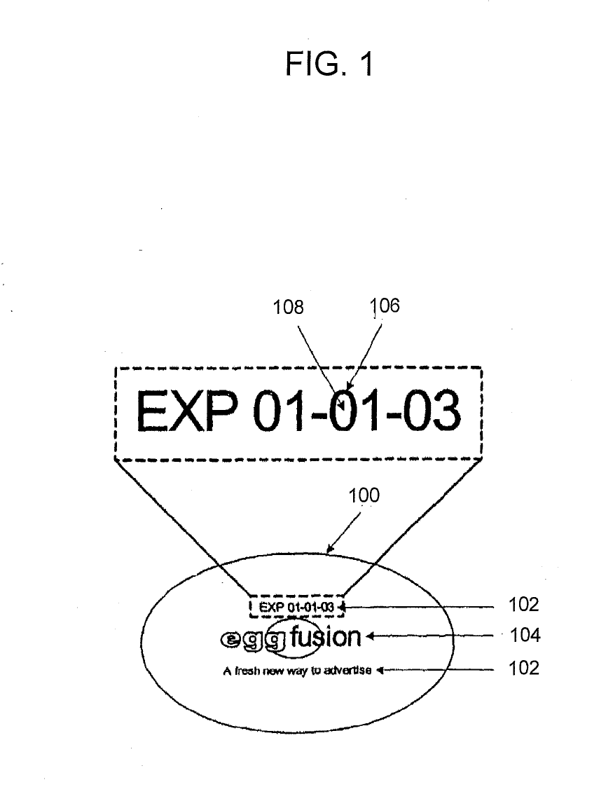

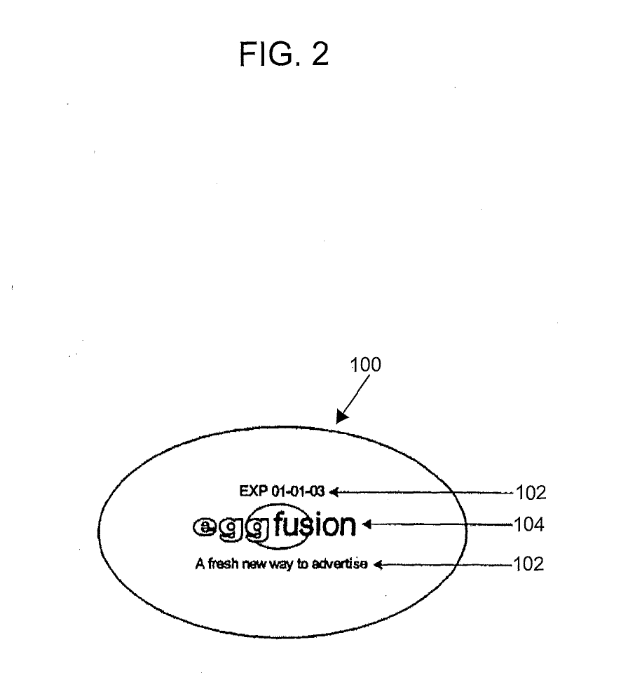

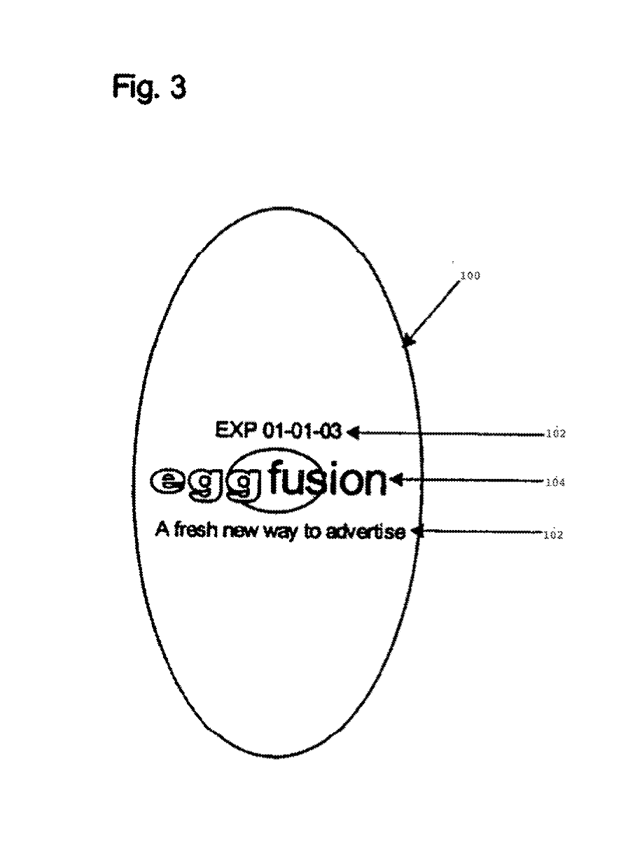

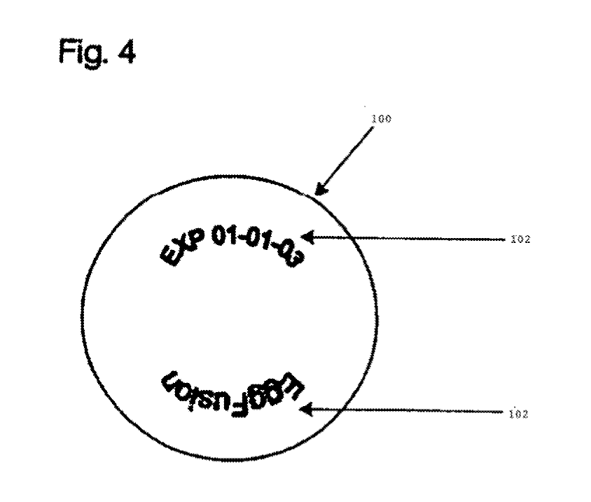

Referring to FIG. 1, an egg 100 is provided with markings or indicia, The markings include text 102 and graphics 104, and can include an advertisement, a sponsored image, or other promotional information as well as a freshness date, a traceability code, or other types of relevant information, or any combination thereof. The markings are formed by discoloring material of the shell to form text 102 and graphics 104, such as that which forms the number 0 as indicated at 106, and leaving other areas of the shell unaffected, such as the area inside the number 0, as indicated at 108. The discoloration may also be done variably so as to form a gradient of discoloration to form the graphics 104, or to create a variety of text 102, such as bold text, italic text, or any type of text or font. That is, some areas may be more discolored than others as, for example, by exposing them to radiant energy for a higher intensity or longer duration (i.e., multiple passes of the radiant energy thereover) than other areas. The text and graphics may be applied horizontally (FIG. 2), vertically (FIG. 3), or on top (FIG. 4) of the egg.

Radiant energy as, for example, electromagnetic radiation such as visible, infrared, or ultraviolet light, can be used to discolor the egg shell. The radiant energy can be controlled to only discolor a targeted print area 106 of the egg shell. Some areas of the egg can be left unaffected 108 (see FIG. 1). The discoloration of the egg shell is easily viewable because of the contrast of the egg shell color 108 to the discoloration 106 from the radiant energy. A significant benefit of the use of laser marking is that brown eggs have etched indicia that is a contrasting white color, while white eggs have etched indicia that is a contrasting dark brown color. The discoloration can be used to form indicia or marking information on the eggs.

The discoloration to form text and graphics can be applied generally simultaneously by one or more radiant energy sources.

In the preferred embodiment in which a radiant energy source is used, no foreign material is required to be added to the egg shell in order for the radiant energy to discolor the egg shell. Thus, no foreign material, such as ink or radiant energy sensitive material that could react with the radiant energy needs to be added to form a marking. The radiant energy is applied to the natural eggshell. Thus, the marking most desirably is formed solely by the effect of the radiant energy on the normally occurring materials of the eggshell itself. This provides several significant benefits. The egg can be properly represented to the consumer as a product with no additives or contaminants. Moreover, because it is not necessary to apply additional materials for purposes of the marking process, it is unnecessary to add the equipment needed to coat the egg with a foreign substance. This greatly simplifies the task of performing the process inline in the production environment of an existing high-speed egg handling apparatus. Additionally, the potentially significant cost of such additional materials is avoided.

In a method according to a preferred embodiment of the present disclosure, a radiant energy source in proximity of an egg directs radiant energy towards the egg. Radiant energy source desirably includes a laser such as a CO₂ gas laser adapted to provide light at a wavelength between 9.0 and 10.7 microns, at a minimum of 25 watts, and a projected maximum of 200 watts radiated power, in a beam projected from approximately 100 mm at the surface of the egg. When operated in this power range, the beam ablates and/or discolors the outer surface material from the egg shell. The structural integrity of the egg shell is not affected because the etching by the beam only affects the outer approximately 5 to approximately 25 micrometers of the egg shell, which is approximately 1.5% to approximately 8% of the thickness of the egg shell. The beam is directed onto those areas of the egg, which are to be discolored and turned on and off so as to provide a series of pulses, the beam being “on” for up to about 60 milliseconds during each pulse. During this pulsed actuation, the beam is swept across those areas of the egg surface, which are to be discolored. The sweeping motion may be performed in any manner which will provide the desired relative motion of the beam and the egg. Since the preferred embodiments will operate in association with an egg-handling machine which moves eggs at an extremely rapid speed, the beam must be rapidly moved to produce the desired indicia and also may compensate for the speed of movement of the eggs past the laser apparatus, which is preferably stationary. For example, the radiant energy source may include a beam-sweeping unit incorporating conventional optical elements such as movable or variable lenses, mirrors or prisms adapted to deflect the beam and to vary the deflection with time. Suitable radiant energy sources include, but are not limited to, Sealed CO₂ Gas Lasers, Slow-flow CO₂ Gas Lasers, TEA CO₂ Mask Lasers, CO₂ Gas Lasers, UV Gas Lasers, Mid-IR Solid State Lasers, and solid state visible light lasers. In other embodiments, the radiant energy source may be also be a YAG-type and/or fiber laser system, and may be coupled with a frequency multiplying optical element.

In another embodiment, an ink-based marking device is placed in proximity of an egg and directs ink toward the egg. Suitable ink-based marking systems include non-contact systems that do not direct contact of the printing system with the egg surface, such as CIJ printing system discussed above. Such system may be mounted so as to mark while the eggs are contained by the calipers on the Grader Chains of an egg grading machine. The system may also be mounted on the Packer and traverse across each row of eggs, applying markings thereon. The CIJ printing system could include a single-jet CIJ printer, a dual-jet CIJ printer, a Binary Array type of CIJ printer, or a drop-on-demand printer system using technologies including Thermal Inkjet (TIJ), Piezoelectric Inkjet, and MEMS-based Inkjet.

Drop-on-Demand technology can offer significantly higher resolution printing than CIJ technologies, thereby offering good potential for creating high-quality desirable sponsored images. Additionally, Drop-on-Demand technology configurations may use ink cartridges (as opposed to a large reservoir and associated pumps, valves, etc.), which can reduce equipment maintenance requirements. Drop-on-Demand technology options may be mounted above the eggs at a Grader processing step before the Grader Transfer, where the eggs travel at a lower speed and the higher resolution print can be better controlled.

Another example of an ink-based marking system is one that is mounted on the packer and uses to six independent ink sources, each arranged above one egg in a row of eggs (each row has up to 6 eggs). As the eggs pass under the ink source in their typical (as though unmarked) path through the packing machinery, ink is sprayed onto the surface of the egg. Such ink source could include the same technology options as discussed above.

In a method according to an embodiment of the present disclosure, an egg moves through a portion of an egg-grading machine. An egg-grading machine grades the quality of the eggs, and may also transport the eggs towards a packaging machine. Egg-grading machines will move the egg along a path. Somewhere along the path, and preferably immediately before the eggs are packed, a predetermined region can be selected where the egg will pass through and radiant energy can form markings on the egg. Typically, egg-grading machines have calipers that hold the eggs at some point in the path of the egg-grading machine. The marking device may be placed in proximity to this point when the eggs are held so that the marking device forms the markings on an egg as it passes through this predetermined region. This eliminates any need for a special apparatus to position the egg. In this way the method is performed inline with the egg-grading machine.

In another embodiment of the present disclosure, a marking device may be placed in proximity of an existing egg-handling machine. Egg-handling machines includes any device or apparatus that will control the movement of an egg along a path, including egg-grading machines. The marking device can be placed in proximity to the egg-handling machine so that the markings may be applied to the egg inline. The egg-handling machine moves an egg along a conveyor apparatus in a particular direction. A marking device is placed in proximity to the conveyor apparatus such that marking device is directed towards an egg.

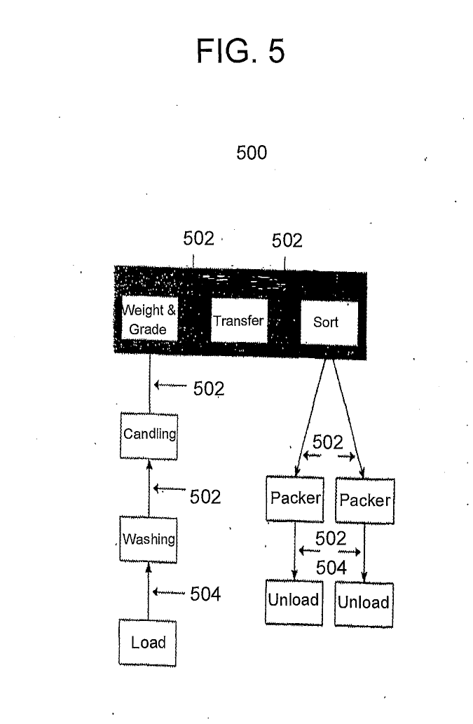

There are many variations of egg-handling machines. Most perform some common minimal basic functions. FIG. 5 is a block diagram outlining the basic functions of those machines. The eggs move through these machines 500 while these basic functions are performed, and a radiant energy source can be placed inline 502 or offline 504 in between many of these functions to perform a method of the present disclosure. The eggs are loaded into the machine. An offline procedure may be performed after this function. The eggs are then washed, after which an inline method may be performed. The eggs are candled, after which an inline method may be performed. The eggs move to the grading portion of the machine where they are weighted and graded, after which an inline method may be performed. The eggs are then transferred to a sorter, before which an inline method may be performed. The eggs are then sorted by grades and sizes, after which an inline method may be performed. The eggs are placed into a package, after which an inline method may be performed. An offline process 504 can be performed prior to the load processor and, typically involves human intervention or some other form of mechanical intervention alien to the egg-handling machine. In preferred embodiments of the present disclosure, the marking device can be associated with an existing egg-handling machine without appreciably modifying the machine. The egg-handling machine preferably includes sensors or other suitable monitoring devices for monitoring the operational and environmental parameters of the egg-handling machine.

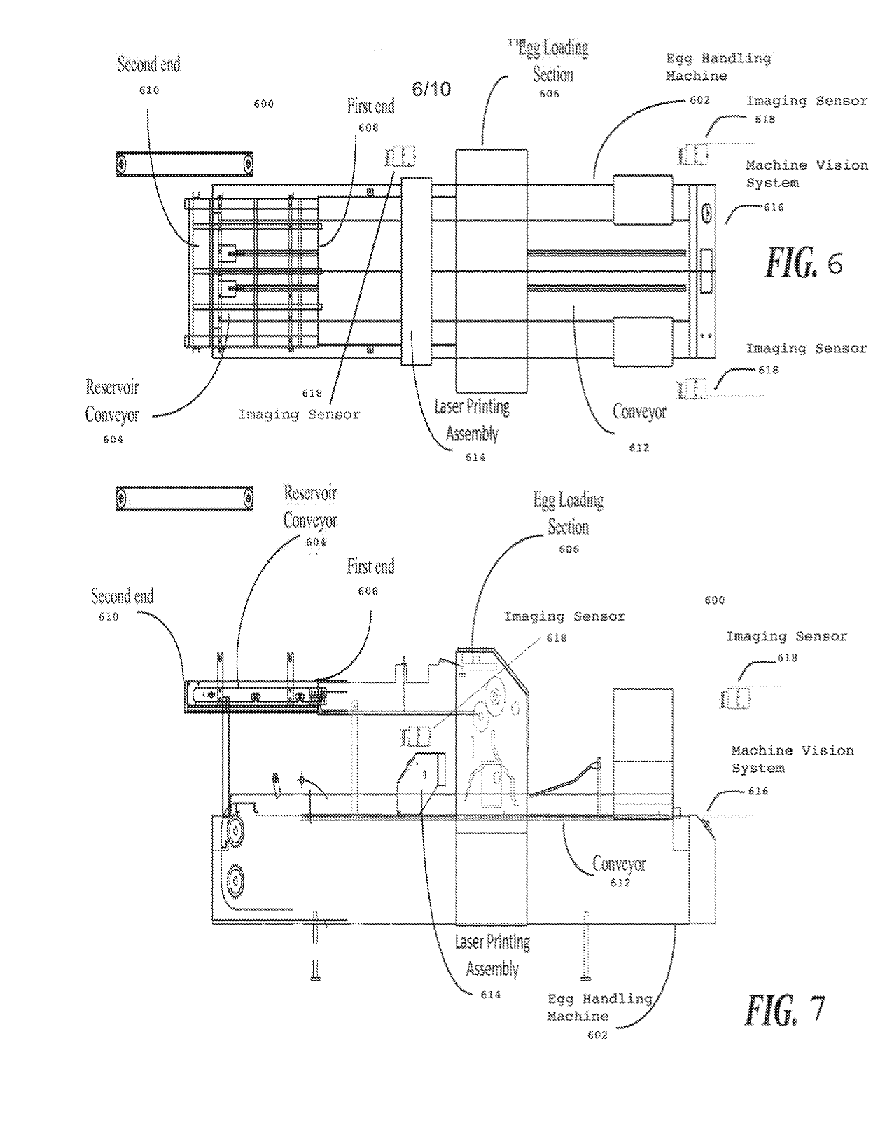

FIG. 6 illustrates a top-view of a system diagram of an example embodiment of an apparatus 600 that is operable in association with an egg-handling machine 602 that performs washing, candling, grading, and packing of eggs as discussed above. The apparatus includes at least one laser printing assembly 614 comprised of at least one laser source operable to apply laser markings on eggs. FIG. 7 illustrates a side view of the system diagram of an example embodiment of apparatus 600 that is operable in association with egg-handling machine 602. While reference is made herein to eggs in particular, it should be understood that the same principles and features may be applied to an apparatus for applying marks on other suitable food products. Further, while reference is made to a laser printing assembly comprised of at least one laser source, it should be understood that any suitable marking device may be used, such as an ink-based printing assembly comprised of at least one ink-based printing head.

A reservoir conveyor 604 is connected to an egg loading section 606 of the egg handling machine 602 at first end 608 and an egg grading machine (not shown) at second end 610. In an example operation, eggs are passed from the egg grading machine (not shown) to the reservoir conveyor 604 via the second end 610. The reservoir conveyor 604 then passes the eggs along the conveyor to the first end 608 and then to the egg loading section 606. The egg loading section 606 then receives an egg package (not shown) along a conveyor 612 and then deposits a plurality of eggs into the egg package. The eggs are deposited in the egg package such that the egg package is open and at least a portion of each of the eggs is accessible. In most instances, at least a portion of the eggs extend above the open egg package. Typically the eggs do not travel continuously down the conveyor belt of conveyor 612. Instead as each set of eggs are placed in the egg package at the egg loading section 606, a pause in the conveyor belt of the conveyor 612 occurs. During this pause or dwell time, the at least one laser source in the laser printing assembly 614 prints data on at least one of the eggs in the open egg carton. Preferably, the at least one laser source prints data on each of the eggs in the open egg carton.

The laser printing assembly may be configured on various configurations depending on the markings to be applied onto the eggs and the egg processing speed required in different embodiments or environments. For example, in one embodiment, the laser printing assembly 614 may be situated at the side of the conveyor 612 at a position where a portion of the egg carton is located below the at least one laser source. In another embodiment, the at least one laser source, or associated beam delivery or beam deflecting or beam focusing elements, may be mounted on a linear slide in the laser printing assembly 614 that moves parallel to the row of eggs during the dwell time and perpendicular to the direction of the conveyor belt of the conveyor 612. Thus, the at least one laser source prints from above the eggs contained in the egg package. The information printed thereon includes text and graphics, and can include an advertisement, a freshness date, a traceability code, or other types of relevant information, or any combination thereof. In those embodiments in which the laser source prints from above the eggs, egg debris and/or broken eggs will not fall onto the laser source and therefore, will not cause downtime or impede print quality.

It is be understood that the at least one printing assembly may be positioned at any suitable location for marking on the food products and that the location referenced herein is only for example purposes. Further, the apparatus may include multiple printing assemblies and such printing assemblies may be configured or positioned as required for effective processing.

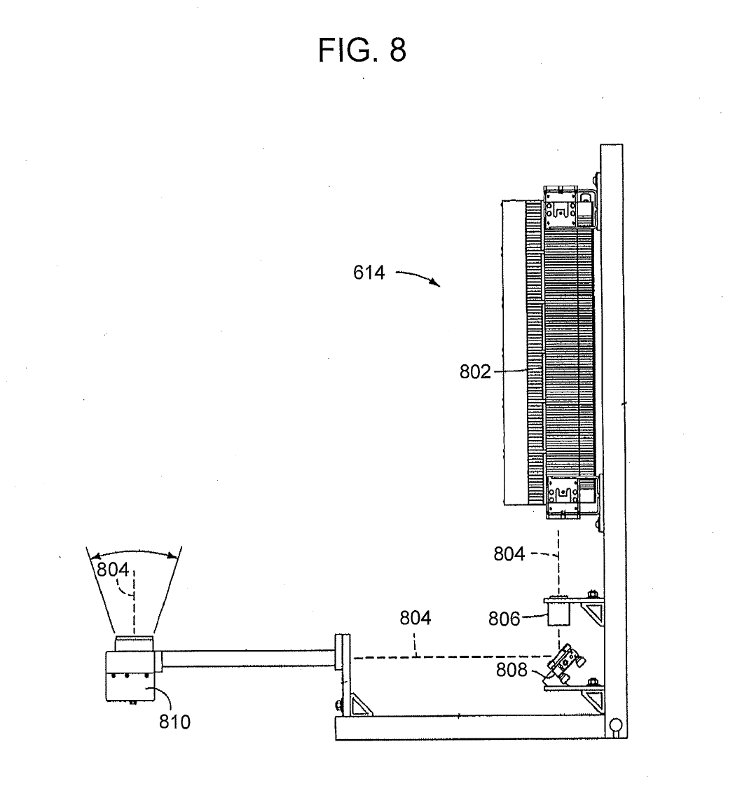

FIG. 8 is a diagram of one embodiment of the laser printing assembly 614 of FIGS. 6 and 7. The laser printing assembly 614 includes at least one laser source 802. The laser source 802 outputs a laser beam 804 that passes through a collimating and focusing lens 806, is then reflected off of mirror 808 to a galvanometer scanning head 810 that directs the laser beam to a specific location on the eggs passing thereunder. The laser printing assembly 614 may also include other components as necessary to interact with the apparatus 600 and apply the desired laser markings to the eggs. The laser printing assembly, which includes at least one laser source, preferably has vector scan and raster scan capability for applying the desired markings to the eggs. The laser printing assembly is in communication with an associated computer, controller, central processing unit, or the like (“computer system”) that controls the operation of the laser printing assembly and the at least one laser source contained therein.

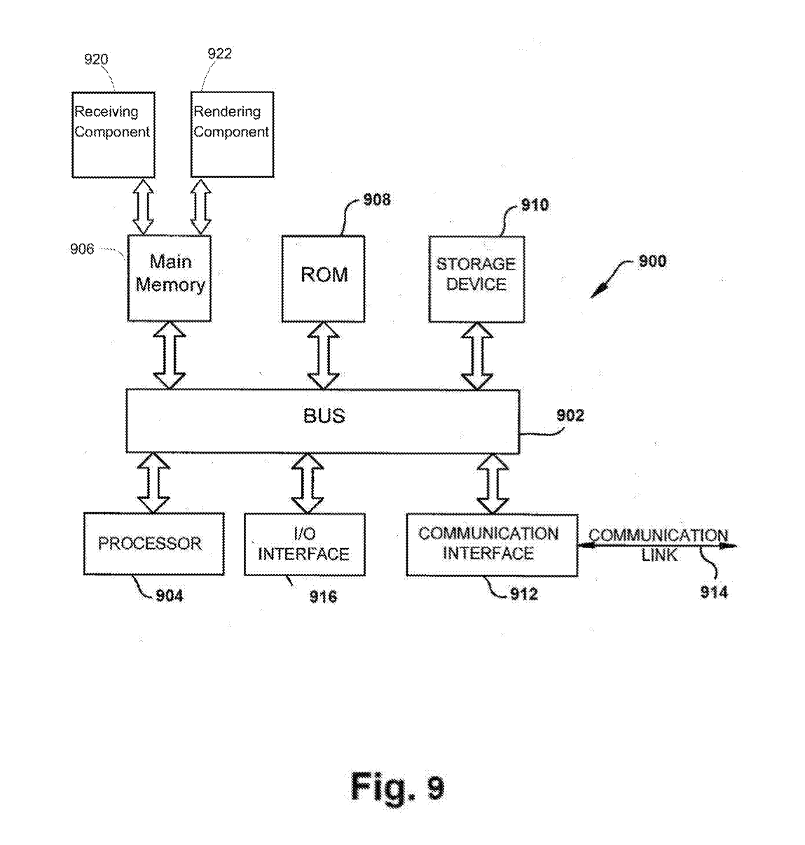

FIG. 9 illustrates an example of a computer system 900 upon which an example embodiment may be implemented. Computer system 900 is suitable for implementing the functionality of any embodiment of the apparatus 600 described herein in FIGS. 6 and 7.

Computer system 900 includes a bus 902 or other communication mechanism for communicating information and a processor 904 coupled with bus 902 for processing information. Computer system 900 also includes a main memory 906, such as random access memory (RAM) or other dynamic storage device coupled to bus 902 for storing information and instructions to be executed by processor 904. Main memory 906 also may be used for storing a temporary variable or other intermediate information during execution of instructions to be executed by processor 904. Computer system 900 further includes a read only memory (ROM) 908 or other static storage device coupled to bus 902 for storing static information and instructions for processor 904. A storage device 910, such as a magnetic disk, optical disk, SD memory and/or flash storage, is provided and coupled to bus 902 for storing information and instructions.

An aspect of the example embodiment is related to the use of computer system 900 to implement the method and system for applying markings to food products. According to an example embodiment, applying markings thereon are provided by computer system 900 in response to processor 904 executing one or more sequences of one or more instructions contained in main memory 906. Such instructions may be read into main memory 906 from another computer-readable medium, such as storage device 910. Execution of the sequence of instructions contained in main memory 906 causes processor 904 to perform the process steps described herein. One or more processors in a multi-processing arrangement may also be employed to execute the sequences of instructions contained in main memory 906. In alternative embodiments, hard-wired circuitry may be used in place of or in combination with software instructions to implement an example embodiment. Thus, embodiments described herein are not limited to any specific combination of hardware circuitry and software.

The term “computer-readable medium” as used herein refers to any medium that participates in providing instructions to processor 904 for execution. Such a medium may take many forms, including but not limited to non-volatile media, and volatile media. Non-volatile media include, for example, optical or magnetic disks, such as storage device 910. Volatile media include dynamic memory, such as main memory 906. As used herein, tangible media may include volatile and non-volatile media. Common forms of computer-readable media include, for example, floppy disk, a flexible disk, hard disk, magnetic cards, paper tape, any other physical medium with patterns of holes, a RAM, a PROM, an EPROM, a FLASHPROM, CD, DVD or any other memory chip or cartridge, or any other medium from which a computer can read.

Various forms of computer-readable media may be involved in carrying one or more sequences of one or more instructions to processor 904 for execution. For example, the instructions may initially be borne on a magnetic disk of a remote computer. The remote computer can load the instructions into its dynamic memory and send the instructions over a telephone line using a modem. A modem local to computer system 900 can receive the data on the telephone line and use an infrared transmitter to convert the data to an infrared signal. An infrared detector coupled to bus 902 can receive the data carried in the infrared signal and place the data on bus 902. Bus 902 carries the data to main memory 906 from which processor 904 retrieves and executes the instructions. The instructions received by main memory 906 may optionally be stored on storage device 910 either before or after execution by processor 904.

The computer system 900 also includes a communication interface 912 coupled to bus 902, for providing a two-way data communication coupling computer system 900 to communication link 914. Communication link 914 typically provides data communication to other networks or devices. Although the illustrated example has one communication interface 912 and one communication link 914, those skilled in the art should readily appreciate that this is for ease of illustration, as the example embodiments described herein may have any physically realizable number of communication interfaces 912, and/or communication links 914. The server 900 may further include at least one input/output interface 916 connected to the bus 902 and in data communication with one or more user interface devices, such as a mouse, keyboard, monitor/screen, etc. (not explicitly shown).

Notably, while the illustrative embodiment described below shows a single computer system as performing the functions described herein, it is understood that the computer system 900 may comprise, either as a single computer system or as a collection of computer systems, one or more memories, one or more processors, and one or more network interfaces (e.g., adapted to communicate traffic for a collaborative computing session and also traffic on a communication channel other than the collaborative computing session), etc., as may be appreciated by those skilled in the art.

The computer system 900 is operable to control the operation of the printing assembly and the at least one printing head contained therein. The computer system 900 is also operable to receive and/or generate data files for producing or generating movement of the marking device to produce the desired markings. The computer system 900 is operable to control various parameters of the marking device, enabling optimization of the performance the marking device which enhances resolution of the applied markings.

In a preferred embodiment, the computer system 900 is operable to control the operation of the laser printing assembly and the at least one laser printing head contained therein. The computer system 900 is also operable to receive and/or generate data files containing vector and/or raster information for producing or generating movement of the marking device to produce the desired markings. The computer system 900 is operable to control various parameters of the laser beam, such as power, spot size, spot area, laser speed, pulse width, pulse frequency, and/or modulation frequency. This enables optimization of laser performance which enhances resolution of the applied markings. The magnitude and character of these parameters may be associated with the vector and raster information and stored in memory and programmably varied according to the desired results.

The computer system 900 is preferably interconnected with other computer systems, sensors devices, and other devices associated with other machines, systems, networks, and the like that interact with the apparatus 600 as set forth in FIGS. 6 and 7. For example, the computer system 900 is preferably interconnected with the computer system that controls and monitors the operation of the egg-handling machine 602. The computer system preferably receives environmental and product information from the egg-handling machine, such as wash water temperature, rinse water temperature, wash water pH values, egg origin and characteristic information, and the like. The computer system also preferably receives information from position sensors which monitor the operating status of all important moving components of the apparatus 600.

In one embodiment, the environmental information, product information, positional information, and other relevant processing information may be obtained using image capturing devices, machine-readable or human-readable sensors and identifiers, radio frequency identification transponders (RFID) or other transmitting sensors, time stamps or biometric identification, object recognition, texture definition, database management, and other software, data interface equipment consisting of serial, parallel, or network communication, binary data such as switches, gates, push buttons, current sensors, as well as additional forms of data input. The computer system 900 processes the obtained data and uses such data in the control and operation of the printing assembly as well as the associated egg-handling machine. By adjusting the characteristics of the marking applied thereon, a more consistent mark is achieved and variations of marking quality between different types of eggs, environments, and the like may be reduced and/or eliminated.

Egg origin and characteristics of the eggs on which the marking is to be applied, or the environmental or processing conditions to which the eggs are subject, may affect the quality of the mark to be applied thereon. These factors include, but are not limited to:
Shell composition (chemical);
Shell composition (mechanical features);
Shell thickness;
Percentage of cuticle remaining;
Shell strength;
Species (chicken, ducks, turkeys, etc.);
Breed of bird;
Feed for bird;
Water source for bird;
Barn temperature;
Molt cycle;
Age of bird;
Age of the egg
Color of egg;
Egg weight (individual and package)
Egg grade
Egg surface temperature at time of lasing;
Egg wetness at time of lasing;
Egg internal temperature at time of lasing;
Thermal conductive coefficient of egg shell;
Curvature of egg relative to the marking;
Egg washing process parameters;
Egg rinsing parameters;
Egg drying parameters;
Temperature and humidity in the packing facility;
Time of day;
Egg packaging parameters;
Peak temperature reached;
Degree of focus of the laser during marking;
Movement of egg during marking;
Temperature of air local to marking point;
Effectiveness of vacuum system.

Data relating to the characteristics associated with eggs or the processing or environmental conditions may be obtained by any suitable means. For example, the egg origin and characteristic information of the eggs may be obtained from the source providing the eggs, inspection/examination prior to the processing, data obtained from previous processing of similar types of eggs, data received or obtained by the computer system 900 during monitoring of the marking process, or any other means. Data relating to the environmental conditions, processing parameters, and the interaction of the laser with the egg shell may be obtained from previous processing of similar types of eggs, data received or obtained by the computer system 900 during monitoring of the marking process, or any other means. The computer system preferably stores the data in memory and uses such data as necessary in the control and operation of the printing assembly as well as in the control and operation of the egg-handling machine.

In accordance with an embodiment of the present disclosure, the performance or characteristics of the marking device may be adjusted in response to selected characteristics of the food product in order to optimize the marking applied thereon. Further, the interaction of the marking device with the food product may be monitored by any suitable means and the characteristics of the marking may be adjusted in response to such parameters. By adjusting the characteristics of the marking applied thereon, a more consistent mark is achieved and variations of marking quality between different types of eggs, environments, and the like may be reduced and/or eliminated.

In a preferred embodiment, the laser performance parameters may be suitably set or adjusted based on the egg characteristics, environmental conditions, processing conditions, interaction with the laser and the egg shell, content to be applied thereon, and combinations thereof. In a preferred embodiment, the computer system 900 controls various parameters of the laser printing assembly and the at least one laser printing head to optimize the laser markings to be applied to the eggs. The parameters that may be set or adjusted include, but are not limited to:
Laser power;
Spot size;
Depth of field;
Speed of traverse of the laser beam over the surface of the object being marked;
Number of passes of the laser beam over the surface of the object being marked;
Dwell-time between passes;
Power settings within/between passes;
Spot size of laser beam within/between passes;
Speed of traverse within/between passes;
Order of passes;
Dwell-time in corners of characters;
Configuration of character fonts;
Configuration of any graphical objects to be marked;
Localized heat buildup;
Laser pulse frequency;
Laser wavelength.

The laser performance parameters may be set or adjusted prior to the laser marking process, during the laser marking process in response to data obtained during processing, or any combination thereof. The laser performance parameters may be set or adjusted per egg, per batch, per run, or any combination thereof. Preferably, the laser performance parameters are adjusted to optimize the laser marking applied thereon such that a more consistent mark is achieved and variations in marking quality are reduced and/or eliminated.

In one embodiment, at least a portion of the eggs are examined or analyzed during and/or after the laser marking process to determine the position and/or characteristics of the eggs that are to be marked and/or the quality and integrity of the information that is marked on the eggs. Any number of environmental and processing conditions may be analyzed to produce a specific optimized or improved marking on the eggs in response to the analyzed conditions. For example, the laser performance parameters may be adjusted by maximizing or increasing the change in color caused by the directed energy from the laser, reducing the chipping or depth of mark caused by the directed energy on the egg shell, increasing the speed at which such change in color can occur, or improving the consistency of any other parameter that may be determined between one egg and another.

In some embodiments, a machine vision system 616 may be configured and arranged so as to the examine the position and characteristics of eggs that are to be marked and/or the quality and integrity of the information that is marked on the eggs. In some embodiments, one or more machine vision observation units or imaging sensors 618 may be positioned, for example, adjacent the laser printing assembly 614. In other embodiments, the one or more imaging sensors 618 may be located elsewhere to allow for adequate observation. In a preferred embodiment, the machine vision system 616 is operable to control the operation of the one or more imaging sensors 618 and to receive image data obtained from the one or more imaging sensors 618. The machine vision system 616 is also operable to receive and transmit data to the computer system 900.

As used herein, the phrase “imaging sensor” refers to a component of a vision system that captures image data, e.g., a camera or other image capturing device. In machine vision systems, one or more imaging sensors are configured and arranged to capture image data of one or more areas of interest within a facility. Imaging sensors include analog video cameras, digital video cameras, color and monochrome cameras, closed-circuit television cameras, charge-coupled device sensors, complementary metal oxide semiconductor sensors, analog and digital cameras, PC cameras, pan-tilt-zoom cameras, web cameras, infra-red imaging devices, and any other devices that can capture image data. The selection of the particular camera type and selection of the connected machine vision system for a particular facility may be based on factors including environmental lighting conditions, the frame rate and data acquisition rate, and the ability to process data from the lens of the camera within the electronic circuitry of the camera control board, the size of the camera and associated electronics, the ease with which the camera can be mounted as well as powered, the lens attributes which are required based on the physical layout of the facility and the relative position of the camera to the area of interest, and the cost of the camera.

In one embodiment, the system as disclosed herein may be stopped if the machine vision system 616 determines that the mark quality has fallen below a certain threshold. In some embodiments, such a system may be a closed-loop such that feedback from the machine vision system 616 may be used to control the printing assembly 614 so as to improve the quality and reliability of the process. For example, feedback from the machine vision system 616 might result in adjustment in the number of passes made, the scan rate, the power level, etc., in order to ensure a desired contrast level is achieved during the marking process. Additionally, or alternatively, the machine vision system 616 may examine the size, color, or other perceptible properties of the eggs to be marked and make appropriate adjustments to the performance parameters and/or process to account for such variables and thereby ensure that image quality stays consistent in spite of such variations.

Data obtained prior to, during, and/or after processing of the eggs is suitably stored in memory for later use. The obtained data may be stored in memory local to the egg processing facility and/or remotely by any suitable means. The obtained data may be accessed and analyzed via any suitable means, such as statistical analysis, to determine any variations, trends, patterns, and the like.

It is understood that it may be undesirable to analyze each egg for cost and processing time reasons. Therefore, in some embodiments, a portion of the eggs processed are routed to a quality analysis station for analysis and examination. The eggs may be routed to such quality analysis station prior to, during, and/or after processing thereof. The eggs are subjected to the analysis and examination as discussed above.

As discussed above, the computer system 900 is operable to control the operation of the printing assembly and the at least one printing head contained therein. The computer system 900 is also operable to receive and/or generate data files for producing or generating movement of the marking device to produce the desired markings. In particular, the computer system 900 is operable to control the printing assembly and the at least one printing head contained therein to produce the text and/or graphics forming an advertisement, sponsored images or communications, other promotional information, or other relevant data to be marked on the food product.

The computer system 900 receives and/or generates the data files for producing the text and/or graphics on the eggs via any suitable means. In one embodiment, the computer system 900 generates the data files based on content, image data, and/or other information (“content information”) received from an associated user, other computer system, device, network, or the like. In a preferred embodiment, the computer system includes a content information receiving component 920, which is any suitable software that enables the computer system 900 to receive content information. In a preferred embodiment, the computer system 900 further includes a content information rendering component 922, which is any suitable software that enables the computer system to render and/or format content information to be applied to the food products. It is to be understood that the content information rendering component 922 suitably renders, formats, or otherwise modifies the received content information to be suitable for marking onto the food products. As used herein, the phrase “render” may be used to describe such rendering, formatting, or modification of the content.

It is to be understood that content information receiving component 920 and content information rendering component 922 may suitably be implemented as logic operable to be executed by processor 904. “Logic”, as used herein, includes but is not limited to hardware, firmware, software and/or combinations of each to perform a function(s) or an action(s), and/or to cause a function or action from another component. For example, based on a desired application or need, logic may include a software controlled microprocessor, discrete logic such as an application specific integrated circuit (“ASIC”), system on a chip (“SoC”), programmable system on a chip (“PSOC”), a programmable/programmed logic device, memory device containing instructions, or the like, or combinational logic embodied in hardware. Logic may also be fully embodied as software stored on a non-transitory, tangible medium which performs a described function when executed by a processor. Logic may suitably comprise one or more modules configured to perform one or more functions.

In a preferred embodiment, the computer system 900 receives the content information from an associated user, other computer system, device, network, or the like via the content information receiving component 920. Content information may be provided to the computer system through the input/output interface 916 via a suitable user interface device, through the communication interface 912 via the communication link 914, via a computer readable medium, or combinations thereof. For example, a user may input the desired content information via a user interface display associated with the computer system. The user may also transmit the content information electronically from a remote location, such as via a remote user interface or electronic mail. The user may also provide a computer readable medium having the content information stored thereon, wherein the content information stored therein is accessed by the computer system for processing.

In one embodiment, the content information receiving component 920 may include the functionality to allow an associated user to select parameters, features or other options for the rendering of the content information provided (“rendering options”). For example, the user may be able to select parameters related to text which is to be rendered (i.e., font size, font type, font color, resolution, complexity, spacing, placement, etc.); and/or images which are to be rendered (i.e., image size, image type, image color, image resolution, image complexity, spacing, placement smoothing operations, etc.). The user may also be able to select parameters related to printing performance parameters, such as power, spot size, spot area, printing speed, number of passes, frequency, and the like. The user may further be able to select parameters associated with the eggs and/or packaging to which the content information is to be applied, such as specific egg(s) on which the information is to be applied, specific egg container(s) on which the information is to be applied, and the like. For example, the user may select that the content information is only applied to selected types of eggs, selected eggs within an egg container, eggs within a selected type of container, and the like. The rendering option data is then associated with the content information and used in the marking of the content information on the eggs and/or packaging.

In some embodiments, the content information may be associated with or include a machine readable code, such as a bar code, two-dimensional code, or other graphic machine readable code. In a preferred embodiment, the machine readable code is a two-dimensional code containing a UPC code that defines the contents of the egg container and data specific to the user or users supplying the content information. In a preferred embodiment, the 2 dimensional code or barcode printed on the carton also has built-in error correction capability, and large pixel sizes, to maximize the readability of the code despite the poor quality of carton printing that is frequently observed. During the marking process, the machine readable code may be used to determine or verify that the content information associated therewith is being properly marked on the food product in accordance with the selected rendering options. If the machine readable code is not recognized by the computer system 900 for any reason, the computer system may adjust the content information to be applied thereon or may stop the marking process. For example, if the machine readable code cannot be accessed or found within the memory, user specific content information associated with the machine readable code may be substituted with non-user specific content information. Further, if the computer system 900 determines that any of the rendering options associated with such machine readable code are not being implemented accordingly, the computer system 900 may stop the marking process. For example, if the computer system 900 detects that the machine readable code specifies that a certain container is to be used and the incorrect container is used, the computer system will stop the marking process to allow for corrective action.

In some embodiments, the content information receiving component 920 may include the functionality to allow the user to review, verify, and/or approve the content information provided, as well as the selected rendering options prior to or upon submission of the content information. For example, the user may be provided with an image showing the content information rendered in accordance with the selected rendering options. Such image may be displayed on a suitable user interface device either locally or remotely. In a preferred embodiment, the user is able to modify or change the content information provided and/or the selected rendering options as desired. The content information provided and/or the selected rendering options may be stored in memory for future use. The content information and rendering options may be stored in memory local to the egg processing facility and/or remotely by any suitable means, and may be accessed and analyzed via any suitable means, such as statistical analysis, to determine any variations, trends, patterns, and the like.

While reference to content information being provided from a user for rendering onto a food product, it is to be understood that content information may be provided from multiple users, and the content information from each of the users may be rendered and applied to the food product. For example, an egg within an egg container may have a marking applied thereon containing content information that is different from at least a portion of other eggs in the container or that is different from content information applied to the associated egg container. Further, an egg may have multiple markings applied thereon, wherein the content information for each marking is not provided from the same user. For example, an egg may have an advertisement applied thereon associated with one user and another advertisement applied thereon associated with another user.

The content information provided to the content information receiving component 920 is transmitted to the content information rendering component 922 to be rendered in accordance with the selected rendering options for applying such content information to the food product. The content information is formatted, modified, or otherwise changed suitable for marking of the information on the food product. The formatting or changing thereof is preferably based on the characteristics of the text and/or images to be rendered, the printing performance parameters, the food product characteristics, the environmental and processing conditions, and any combination thereof.

Typically, advertisements, sponsored images or communications, and other promotional information are comprised of complex text and/or graphic representations. When an involved text or graphic representation is to be marked on an egg or other food product, it is accomplished by mapping a plurality of vectors on a physical grid. The start and stop coordinates of every vector have to be programmed. This is generally done with an automatic conversion tool from web images that are used in various steps to produce a vector representation of the image. It may also be necessary to manually render certain types of graphics to obtain the right style of the graphic. Based on the fact that the eggs or other food products are moving at a predetermined speed and the printing performance patterns are known, the marking or writing speed is determined to render the image based on those parameters and to determine whether the representation can be effectively rendered. If all of the vectors cannot be etched in the allotted time, the representation must be redacted or simplified by any suitable means to reduce the content of the representation while maintaining realistic visual fidelity of the representation. Two processes for simplifying complex representations or content information include vector thinning and raster scanning.

Vector thinning involves a process for simplifying the representation by reducing the number of vectors using any suitable algorithm. The method for removing intermediate points, i.e., vectors, consists of joining the two ends of the line with a straight line, called the base line. The perpendicular distances of all intermediate points from this base line are then calculated. If all these distances are less than some predefined tolerance, representing half the width of the graphic line at source scale, these points may be discarded and the original line can be represented by the base line. If any of the intermediate points fall outside the tolerance band, the line is split into two parts at the furthest point and the process is repeatedly applied to the two resulting parts.

Raster scanning involves rasterizing all of the vectors onto a fixed grid that enables the determination of the existence of coincident points, which is a process for removing redundant coordinates. When points of two vectors are coincident with one another, one is preferably eliminated. The grid is defined and vectors are drawn on the grid from longest to smallest. If a new vector is drawn without changing any of the grid, that means it is on top of another, and the point or points of coincidence are removed by turning off the laser at those points. This raster thinning eliminates vector elements that provide no additional graphics artifacts. It is not technically a graphics grid, but is an internal memory grid. When vectors are rasterized from longest to smallest, if the small vectors are not shading new grid squares, then nothing is being added to the final rendering and they are eliminated.

As discussed above, if the content information as provided cannot be rendered as provided, the content information must be redacted or simplified reducing the content thereof. Such redaction process is performed by the content information rendering component 922 and improves the quality of the content information and/or reduces the marking time. The redaction may reduce the complexity of any images or text by reducing the number of pixels therein, changing the depth thereof, changing the color, and the like. Further examples, include, but are not limited to:
Use of single-line fonts for text, in place of outline fonts;
Use of single-line or outline fonts for text, in place of filled fonts;
Use of outline graphical objects in place of filled graphical objects;
Reconfiguration of the image to facilitate successful representation using a reduced number of colors;
Reduction of text size (height, width) to reduce marking time;
Increase in character size or separation to improve readability;
Use of complex text fonts in place of graphical objects;
Removal of sharp corners in graphical objects to avoid localized heat buildup;
Sub-division of graphical objects to facilitate improved marking performance;
Sub-division of text objects to facilitate improved marking performance;
Reduction of character count to reduce marking time;
Removal or smoothing of small ancillary features in a graphical object to retain the overall form but reduce marking time and localized heat buildup;
Generation of marking options based on maximum marking area (tapestry).

The content information as rendered by the content information rendering component 922 is then applied or marked onto the food product by the printing assembly in accordance with selected performance parameters.

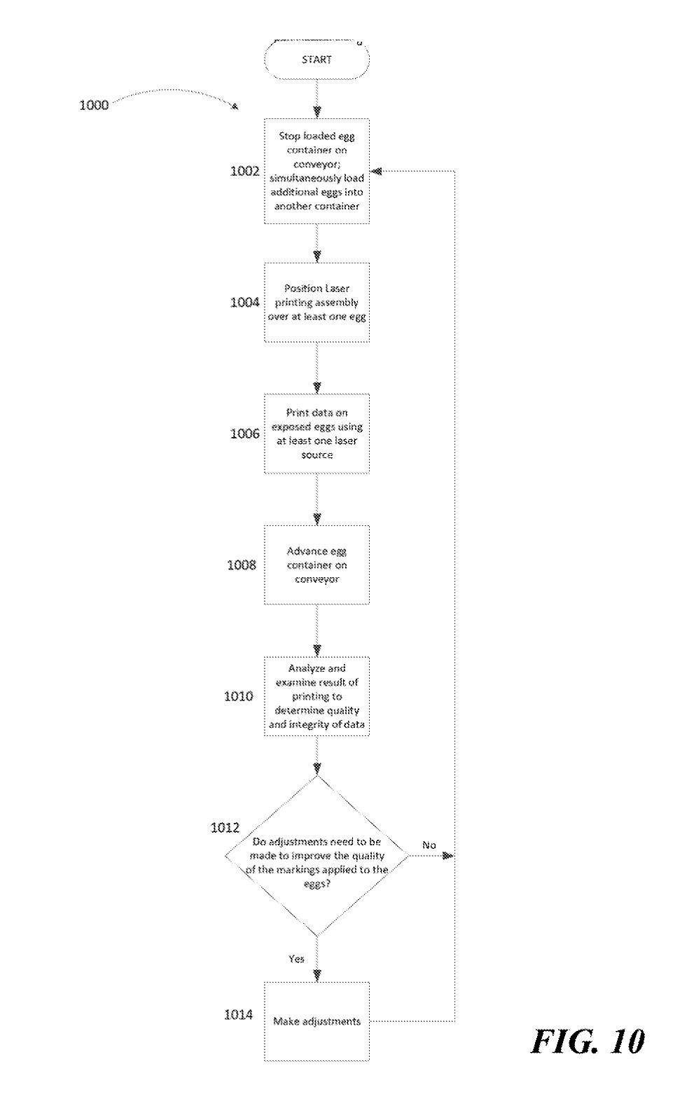

FIG. 10 is an example flow diagram 1000 of laser marking on eggs with the apparatus 600 as shown in FIGS. 6 and 7 in accordance with an example implementation. An egg carton stops for a predetermined period of time under the egg loading section 606 which loads the eggs into an egg container. Simultaneously while an egg container is being loaded by the egg loading section 606, a loaded egg container is stopped on the conveyor 612 under the laser printing assembly 614 as shown at 1002. The at least one laser source contained within the laser printing assembly 614 is positioned over at least one egg in the egg container as shown at 1004. The at least one laser source prints data onto the exposed eggs in accordance with the desired rendering options and laser performance parameters as shown at 1006. The egg container is then advanced on the conveyor 612 as additional eggs are placed in an egg container by the egg loading section 606 as shown at 1008. At 1010, the eggs having data printed thereon are analyzed and examined as discussed above to determine the quality and integrity of the data printed thereon as well as the structural integrity of the eggs. In response to such analysis and examination, the computer system 900 or any other suitable means determines if any of the laser performance parameters, environmental conditions, and/or processing conditions need to be adjusted to improve the quality of the markings applied to the eggs as shown at 1012. If it is determined that certain parameters and/or conditions need to be adjusted, such adjustments are made by any suitable means as shown at 1014. The next container of eggs is then processed according to such parameters and laser marking process continues again as shown at 1002. If it is determined that the parameters do not need adjusted, the laser marking continues again as shown at 1002.

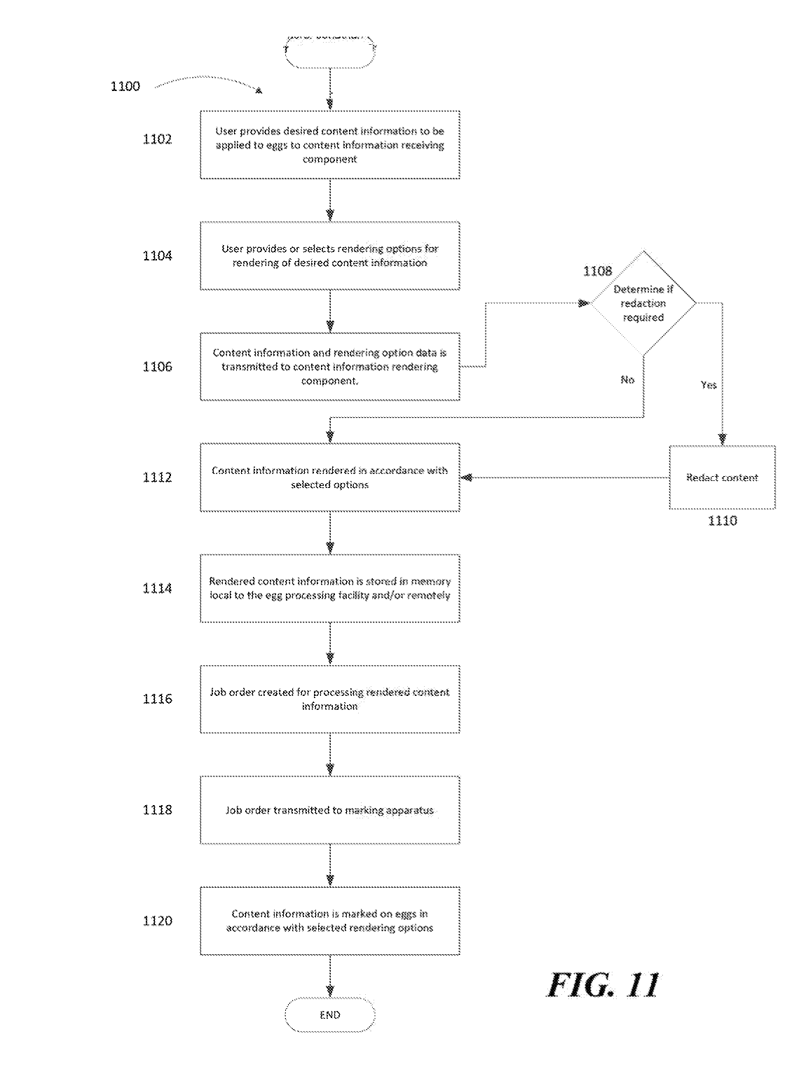

FIG. 11 is an example flow diagram 1100 of marking content information on eggs with the apparatus 600 as shown in FIGS. 6 and 7 in accordance with an example implementation. A user desires to have an advertisement, sponsored images, or other promotional material marked on eggs. At 1102, the user provides the desired content information to be applied to the eggs to the content information receiving component 920 by any suitable means. At 1104, the user provides or selects rendering options for the rendering of the content information provided. The rendering option data is then associated with the content information and used in the marking of the content information on the eggs. The content information as well as the rendering option data is transmitted to the content information rendering component 922 as shown at 1106.

At 1108, a determination is made whether the content information may be rendered as provided based on the characteristics of the text and/or images to be rendered, the printing performance parameters, the food product characteristics, the environmental and processing conditions, and any combination thereof. If it is determined that the content may be rendered as provided, flow proceeds to 1112. If it is determined that the content information cannot be rendered as provided, flow proceeds to 1110, wherein a redaction process is performed thereon by the content information rendering component 922

The content information is then rendered in accordance with the selected options for suitable marking of the information on the eggs as shown at 1112. At 1114, the rendered content information is stored in memory local to the egg processing facility and/or remotely by any suitable means for future use. A job order is then created for processing the rendered content information as shown at 1116. The job order is then transmitted to a selected marking apparatus by any suitable means as shown at 1118. For example, the job order may be transmitted to a computer system associated with a selected egg processing facility. From there, such computer system may transmit the job order to one or more marking apparatuses within the egg processing facility for processing of the content information thereon. At 1120, the content information is marked on the eggs in accordance with the selected rendering options.

Illustrative examples of a marking process for marking advertisements on eggs in accordance with the present disclosure are provided below. A single user (aka Sponsor) creates multiple sets of content information each for an individual image and/or desired mark content, as per step 1102. Each set of content information is processed through steps 1104-1112 so that rendered content information is stored for each instance of content information. The user selects any desired number of those instances of content information, and groups them into a ‘marking sequence’. A ‘marking sequence’ contains data describing the required pattern of marks across all eggs to be marked as part of a single run through the sequence. As described in step 1116, a job order is then created that includes all of the required marks, and the required sequence of those required marks. The job order itself and all associated rendered content information required by the marking system to complete those marks, is transmitted to the marking apparatus as described at step 1118. As eggs are processed by the marking system, each individual egg is marked with the correct information, according to the sequence of marks specified by the user (aka sponsor). Once the sequence is complete, the next egg presented to a marking system is marked with the first instance of rendered content information in the sequence. This sequence continues until the job is deemed complete for any reason (typically that the total number of required eggs has been processed).

Multiple users (aka sponsors) create content information and accept the redacted/rendered images to be marked on eggs. Such sponsors are grouped together under a commercial arrangement, and sets of mark content information are grouped together accordingly. In this manner multiple users (aka sponsors) can share the cost of the marking process, each receiving a commensurate value from the proportion of eggs marked with their selected content information.

In some embodiments, advertisers (aka sponsors) may choose to create ‘geographically-constrained’ job orders that are specific to a geographic region, such as one or more DMAs (Designated Market Areas), in order to target consumers in that region with the advertising or other promotional or communications content that has been marked on the food products or the food product cartons.

In some embodiments, advertisers (aka sponsors) may choose to create ‘time-constrained’ job orders that a specific to a certain period of time, with a start date and an end date for that job to be processed at the processing facility where the food product is packaged. Additionally some dates may be adjusted automatically by the disclosed systems to allow for the transit time from the food processing facility, via transportation to a Distribution Center, and onwards transportation to the grocery store or other retail location where the consumer purchases the food products as packaged and marked with the advertiser- or sponsor-specific information. Thus the advertiser (aka sponsor) can be assured that the requested food products will arrive at the grocery store on or around the intended date, independent of the transit time from the food processing facility to the retail location. Information on the expected transit times can be stored in the cloud and adjusted on a facility-by-facility basis, and a time basis (for instance weekly or daily updates) based on current production and demand conditions, so that the most predictable product arrival at retail can be achieved.

In some embodiments of the disclosed systems, advertisers (aka sponsors) may choose to create ‘product-constrained’ job orders that are specific to a particular brand of product, size of package, size of product, or other product characteristics (for example to mark only Jumbo brown eggs that are branded and therefore destined for a specific retailer). Subject to these constraints, the disclosed systems may prepare a schedule for food processing facilities equipped with the disclosed marking systems, and whenever that specific packaging and product is being processed in the facility, will apply the advertiser- or sponsor-selected markings to that product, without requiring specific timely actions by persons at the food processing facilities.

In some embodiments of the disclosed systems, detailed mark count data is collected at the food processing facility regarding the products processed and any marking applied to the products or associated packaging. Such data is transmitted via any suitable means to offsite data storage where it can be accessed for the preparation of billing invoices for markings, or for verification of actual production locations, dates and volumes, or any other required purpose

In some embodiments of the disclosed systems, advertisers (aka sponsors) may choose to create job orders that are one or more of geographically constrained, product-constrained and/or time-constrained, as described above, according to their commercial considerations and requirements

Having thus described certain embodiments of systems and methods for practicing aspects of the present disclosure, it is to be appreciated that various alterations, modifications, and improvements will readily occur to those skilled in the art. Such alterations, modifications, and improvements are intended to be part of this disclosure, and are intended to be within the spirit and scope of this disclosure.

1. A system for marking individual objects with selected content at a marking station while the objects travel along at least one path through a processing system, the system comprising:
at least one processor operable to control marking of individual objects;
at least one marking unit operatively coupled to the at least one processor and controlled in part by the at least one processor, the at least one marking unit positioned adjacent at least one path along which the objects are conveyed, the at least one marking unit operable to mark the objects as the objects pass through the marking station; and
a non-transient memory operatively coupled to the at least one processor and operable to store data associated with the marking of the objects;
at least one input/output interface operatively coupled to the processor;
wherein the least one processor is operable to:
obtain content marking parameters comprising at least one of content to be marked thereon, at least one rendering parameter associated with marking of the content thereon, at least one characteristic of the individual objects to be marked, and combinations thereof;
determine whether the selected content is able to be marked on the individual objects in accordance with at least a portion of the content marking parameters;
render the selected content in accordance with at least a portion of the content marking parameters;
mark the individual objects with the selected content by the at least one marking unit in accordance with at least a portion of the content marking parameters.

2. The system of claim 1, wherein in the event a determination is made that the selected content cannot be rendered in accordance with at least a portion of the content marking parameters, the at least one processor is further operable to:
perform a redaction process on the content to reduce the complexity thereof;
render the redacted content in accordance with at least portion of the content marking parameters; and
mark the individual objects with the selected content by the at least one marking unit in accordance with at least a portion of the content marking parameters.

3. The system of claim 1, wherein the at least one marking unit is a laser marking unit, and the processor is operable to direct at least one laser beam from the at the least one laser marking unit onto the objects to mark the selected content thereon.

4. The system of claim 1, wherein the individual objects are individual eggs.

5. The system of claim 1, wherein the selected content to be marked on the objects comprises at least one of text, graphics, and any combination thereof, and includes at least one of advertisements, sponsored images, freshness information, traceability data, source information, and any combination thereof.

6. The system of claim 1, wherein the at least one rendering parameter comprises at least one of at least one parameter associated with text, graphics, images, and combinations included in the content, at least one operational parameter of the at least one marking unit, at least one parameter associated with which objects are to be marked, and combinations thereof.

7. The system of 1, wherein the processor is further operable to receive at least a portion of the content marking parameters from at least one associated user via the at least one input/output interface.

8. The system of claim 1, wherein the at least one processor is further operable to:
receive at least a portion of the content marking parameters from multiple associated users via the at least one input/output interface;
generate aggregate content marking parameters based on the content marking parameters received from at least a portion of the multiple users;
determine whether the selected content is able to be marked on the individual objects in accordance with at least a portion of the aggregate content marking parameters;
render the selected content in accordance with at least a portion of the aggregate content marking parameters;
mark the individual objects with the selected content by the at least one marking unit in accordance with at least a portion of the aggregate content marking parameters.

9. The system of claim 1, wherein the at least one processor is further operable to store at least a portion of the content marking parameters in the non-transient memory.

10. A method for marking individual objects with selected content at a marking station while the objects travel along at least one path through a processing system, wherein at least one marking unit is positioned adjacent at least one path along which the objects are conveyed, the at least one marking unit operable to mark the objects as the objects pass through the marking station, the method comprising:
obtaining content marking parameters comprising at least one of content to be marked thereon, at least one rendering parameter associated with marking of the content thereon, at least one characteristic of the individual objects to be marked, and combinations thereof;
determining whether the selected content is able to be marked on the individual objects in accordance with at least a portion of the content marking parameters;
rendering the selected content in accordance with at least a portion of the content marking parameters;
marking the individual objects with the selected content by the at least one marking unit in accordance with at least a portion of the content marking parameters.

11. The method of claim 10, wherein in the event a determination is made that the selected content cannot be rendered in accordance with at least a portion of the content marking parameters, the method further comprising:
performing a redaction process on the content to reduce the complexity thereof;
rendering the redacted content in accordance with at least portion of the content marking parameters; and
marking the individual objects with the selected content by the at least one marking unit in accordance with at least a portion of the content marking parameters.

12. The method of claim 11, wherein the at least one marking unit is a laser marking unit and directs at least one laser beam therefrom onto the objects to mark the selected content thereon.

13. The method of claim 10, wherein the individual objects are individual eggs.

14. The method of claim 10, wherein the selected content to be marked on the objects comprises at least one of text, graphics, and any combination thereof, and includes at least one of advertisements, sponsored images, freshness information, traceability data, source information, and any combination thereof.

15. The method of claim 10, wherein the at least one rendering parameter comprises at least one of at least one parameter associated with text, graphics, images, and combinations included in the content, at least one operational parameter of the at least one marking unit, at least one parameter associated with which objects are to be marked, and combinations thereof.

16. The method of 10, wherein the method further comprises receiving at least a portion of the content marking parameters from at least one associated user via at least one input/output interface.

17. The method of claim 10, wherein the method further comprises:
receiving at least a portion of the content marking parameters from multiple associated users via at least one input/output interface;
generating aggregate content marking parameters based on the content marking parameters received from at least a portion of the multiple users;
determining whether the selected content is able to be marked on the individual objects in accordance with at least a portion of the aggregate content marking parameters;
rendering the selected content in accordance with at least a portion of the aggregate content marking parameters;
marking the individual objects with the selected content by the at least one marking unit in accordance with at least a portion of the aggregate content marking parameters.

18. The method of claim 10, wherein method further comprises storing at least a portion of the content marking parameters in associated non-transient memory.

19. An apparatus for laser marking eggs with selected content at a marking station, the apparatus comprising:
at least one processor operable to control the laser marking of the eggs;
at least one laser marking unit operatively coupled to the at least one processor and controlled in part by the at least one processor, the at least one laser marking unit positioned adjacent at least one path along which the eggs are conveyed, the at least one laser marking unit operable to direct at least one laser beam to mark the eggs as the eggs pass through the marking station; and
a non-transient memory operatively coupled to the at least one processor and operable to store data associated with the marking of the objects;
wherein the least one processor is operable to:
obtain content marking parameters comprising at least one of content to be marked thereon, at least one rendering parameter associated with marking of the content thereon, at least one characteristic of the individual objects to be marked, and combinations thereof;
determine whether the selected content is able to be marked on the individual objects in accordance with at least a portion of the content marking parameters;
render the selected content in accordance with at least a portion of the content marking parameters;
direct at least one laser beam from at the least one laser marking unit to mark the individual objects with the selected content in accordance with at least a portion of the content marking parameters.

20. The apparatus of claim 19, wherein in the event a determination is made that the selected content cannot be rendered in accordance with at least a portion of the content marking parameters, the at least one processor is further operable to:
perform a redaction process on the content to reduce the complexity thereof;
render the redacted content in accordance with at least portion of the content marking parameters; and
direct at least one laser beam from at the least one laser marking unit to mark the individual objects with the selected content in accordance with at least a portion of the content marking parameters.
